(19) United States
(12) Patent Application Publication
(10) Pub. No.: US 2018/0361926 A1
(43) Pub. Date: Dec. 20, 2018

(54) FOLDABLE DRIVING MECHANISM AND WARNING DEVICE USING THE SAME

(71) Applicant: HONGFUJIN PRECISION ELECTRONICS (TIANJIN) CO.,LTD., Tianjin (CN)

(72) Inventors: CHUANG-WEI TSENG, New Taipei (TW); YU-CHING CHIEN, New Taipei (TW); CHE-HSUN CHEN, New Taipei (TW); CHI-MING HUANG, New Taipei (TW)

(21) Appl. No.: 15/640,591

(22) Filed: Jul. 3, 2017

(30) Foreign Application Priority Data
Jun. 19, 2017 (CN) 201710466802.5

(51) Int. Cl. B60Q 7/00; G09F 13/16; G09F 21/00

(52) U.S. Cl. CPC B60Q 7/005; G09F 21/00; G09F 13/16

(57) ABSTRACT

A traffic warning device includes a reflective warning plate and a foldable driving mechanism. The foldable driving mechanism includes a supporting bracket; a warning sign mounted to an upper side of the supporting bracket, and a plurality of walking or motion units mounted to a lower side of the supporting bracket. Each walking unit includes a supporting leg, a wheel rotatably connected to an end of the supporting leg, and a fastening unit. The other end of the supporting leg is rotatably connected to the supporting bracket. The supporting leg is rotatable between a folded position and a deployed position. The foldable driving mechanism is also disclosed.

### FIELD

The subject matter herein generally relates to a foldable driving mechanism and warning devices using the foldable driving mechanism.

### BACKGROUND

Rear-end collisions are generally caused by, after a front vehicle is involved in an accident or breakdown, an advance-warning not being promptly given, which causes the vehicles behind to collide with it. The rear-end collisions are also caused by the poor visibility and closeness to the accident scene of the warning equipment of the vehicle involved in the accident, the following vehicles do not have sufficient time or distance do respond. As required by transportation authorities, after a road accident, an advance-warning device, such as a warning triangle, must be used to warn the vehicles behind, at a distance of 100-250 meters. A warning triangle's size may make it difficult to store in a small space. That is, if the length of a trunk lid is shorter than the height of the warning triangle, the triangle cannot be kept in that trunk. Therefore, a foldable warning device is needed.

### BRIEF DESCRIPTION OF THE DRAWINGS

Implementations of the present technology will now be described, by way of example only, with reference to the attached figures.

FIG. 1 is an isometric view of a first exemplary embodiment of a warning device.

FIG. 2 is an isometric view of the warning device of FIG. 1 in another state.

FIG. 3 is an isometric view of a second exemplary embodiment of a warning device.

FIG. 4 is an isometric view of the warning device of FIG. 3 in another state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

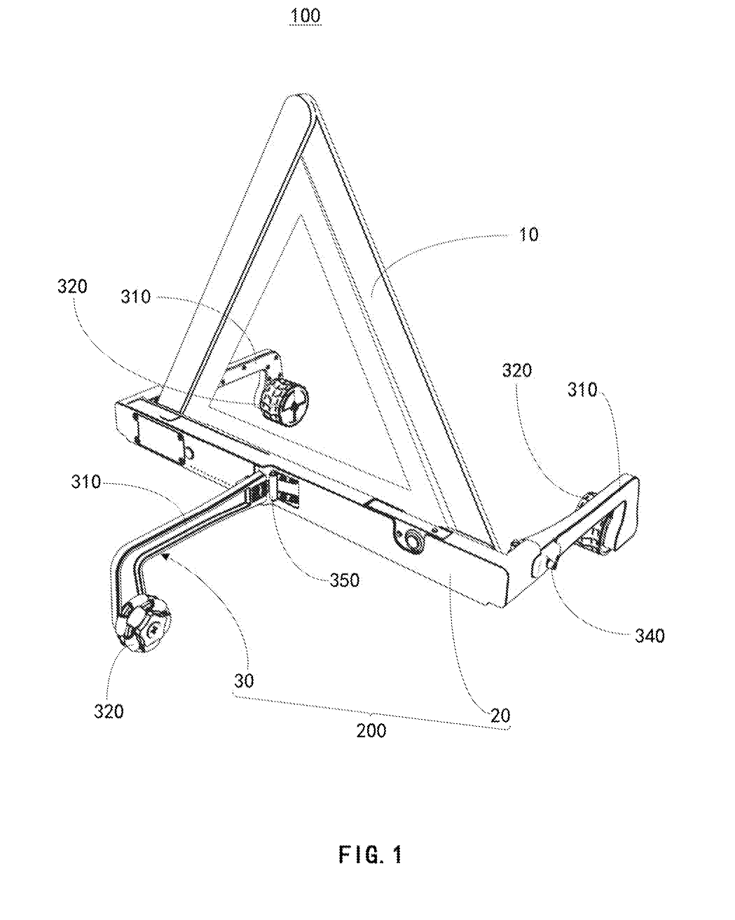

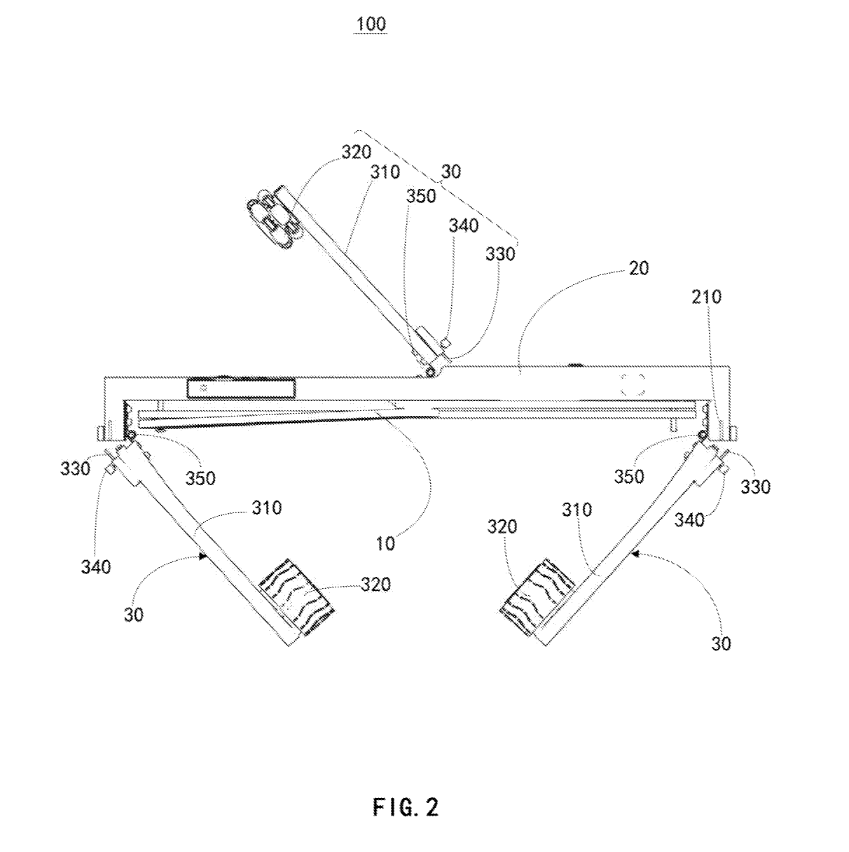

FIGS. 1 to 2 illustrate a warning device 100 according to a first exemplary embodiment of the present application.

The warning device 100 can include a warning sign 10 and a foldable driving mechanism 200. The foldable driving mechanism 200 can include a supporting bracket 20 and three walking units 30.

The three walking units 30 can be mounted to a lower side of the supporting bracket 20, and the warning sign 10 can be mounted to an upper side of the supporting bracket 20. One of the three walking units 30 can be connected to a central portion of a front side of the supporting bracket 20, and the other two walking units 30 can be connected to ends of a rear side of the supporting bracket 20.

The warning sign 20 can be triangle plate covered by reflecting materials, so that the warning sign 20 can reflect light.

Each of the three walking units 30 can include a supporting leg 310, a wheel 320, a fastening unit (not labeled) and a rotating member 350. The wheel 310 is rotatably connected to an end of the supporting leg 310, and the other end of the supporting leg 310 is rotatably connected to the supporting bracket 20 through the rotating member 350.

The supporting leg 310 is rotatable between a folding position, where the supporting leg is folded to the supporting bracket 20, and a walking position (as shown in FIG. 1), where the supporting leg 310 is substantially perpendicular to the supporting bracket 20. When the supporting leg 310 is rotated to the walking position, the supporting leg 310 is fastened to the supporting bracket 20 by the fastening unit.

When the supporting leg 310 is rotated to the folding position, the supporting leg 310 can be substantially parallel to the supporting bracket 20 and the supporting leg 310 abuts the supporting bracket 20.

In at least one exemplary embodiment, at least one of the three walking units 30 further includes a driving unit (not shown), the driving unit is drivingly connected to the wheel 320 of the walking unit 30. With the driving unit, the warning device 100 can be self-propelled.

The fastening unit can include a tenon part 330 and a clamping groove 210 coupling with the tenon part 330. The tenon part 330 is installed to the supporting leg 310. The clamping grove 310 is defined on the supporting bracket 20. When the supporting leg 310 is rotated to the walking position, the tenon part 330 is fastened to the clamping groove 310.

For example, the tenon part 330 can be a tenon pole, and the tenon pole is slidably connected to the supporting leg 310. The tenon pole is slidable between a clamping position, where the tenon pole is inserted into the clamping groove 210, and a releasing position, where the tenon pole is separated from the clamping groove 210.

The fastening unit can further include a locking member (not shown). The locking member can be installed to the supporting leg 310 and coupled with the tenon pole. When the tenon pole is inserted into the clamping groove 310, the tennon pole is locked at the clamping position by the locking member.

For example, the locking member can be a spring connected between an end of the tenon pole and the supporting leg 310. When the tenon pole is inserted into the clamping groove 210, the tennon pole is locked at the clamping position by tension of the spring.

The tenon pole can define a handle 340, so that the tenon pole can be moved by hand.

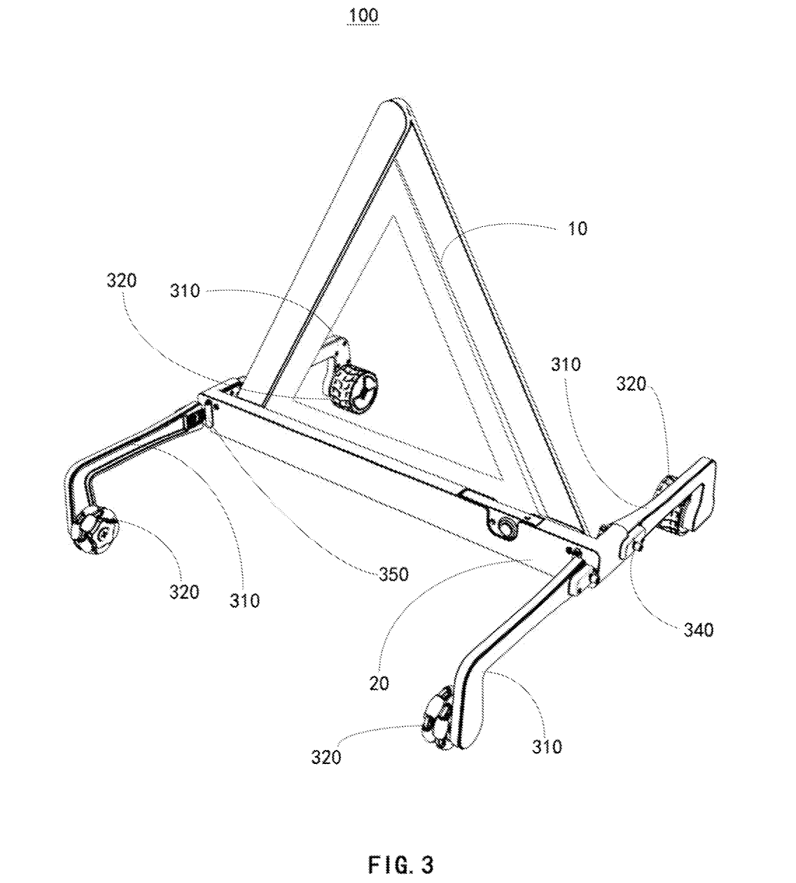

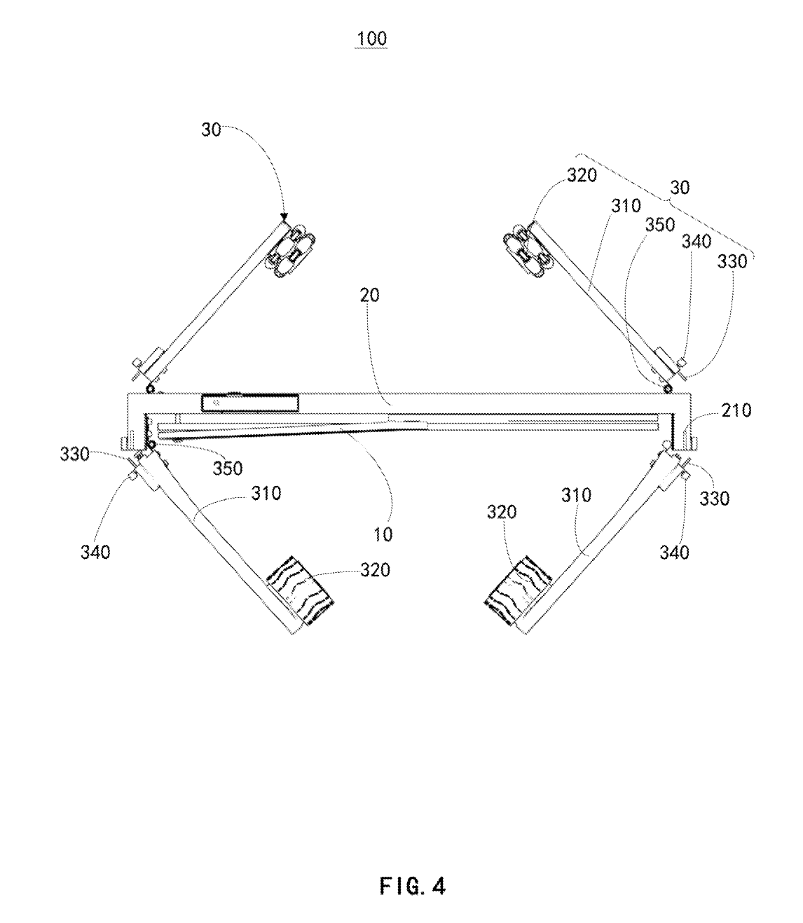

FIGS. 3 to 4 illustrate a warning device 100 according to a second exemplary embodiment of the present application. The differences between warning device 100 in the first exemplary embodiment and the second exemplary embodiment is explained below.

In the second exemplary embodiment, with similar numerals representing similar features in FIGS. 1 and 2, the foldable driving mechanism 200 includes four walking units 30. Two of the four walking units 30 are connected to ends of a front side of the supporting bracket 20, and the other two walking units 30 are connected to ends of a rear side of the supporting bracket 20.

It is understood that the number of the walking units 30 can be other quantities.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

1. A foldable driving mechanism comprising:
a supporting bracket; and
a plurality of walking units mounted to a lower side of the supporting bracket, each of the plurality of walking units comprises:
a supporting leg;
a wheel rotatably connected to an end of the supporting leg; and
a fastening unit comprising:
a tenon part installed to the supporting leg; and
a clamping groove coupling with the tenon part, wherein the clamping grove is defined on the supporting bracket;
wherein another end of the supporting leg is rotatably connected to the supporting bracket; the supporting leg is rotatable between a folding position, where the supporting leg is folded to the supporting bracket, and a walking position, where the supporting leg is substantially perpendicular to the supporting bracket and fastened to the supporting bracket by the fastening unit; when the supporting leg is rotated to the walking position, the tenon part is fastened to the clamping groove; the tenon part is a tenon pole slidably connected to the supporting leg, wherein the tenon pole is slidable between a clamping position, where the tenon pole is inserted into the clamping groove, and a releasing position, where the tenon pole is separated from the clamping groove.

2. The foldable driving mechanism of claim 1, wherein when the supporting leg is rotated to the folding position, the supporting leg is substantially parallel to the supporting bracket and abuts the supporting bracket.

3. The foldable driving mechanism of claim 1, wherein the foldable driving mechanism comprises three walking units, one of the three walking units is connected to a central portion of a front side of the supporting bracket; another two walking units are respectively connected to two ends of a rear side of the supporting bracket.

4. The foldable driving mechanism of claim 1, wherein the foldable driving mechanism comprises four walking units, two of the four walking units are respectively connected to two ends of a front side of the supporting bracket; another two walking units are respectively connected to two ends of a rear side of the supporting bracket.

5-9. (canceled)

10. The foldable driving mechanism of claim 1, wherein the tenon pole includes a handle.

11. A warning device comprising:
a foldable driving mechanism comprising:
a supporting bracket; and
a plurality of walking units mounted to a lower side of the supporting bracket, each of the plurality of walking units comprises:
a supporting leg;
a wheel rotatably connected to an end of the supporting leg; and
a fastening unit comprising:
a tenon part installed to the supporting leg; and
a clamping groove coupling with the tenon part, wherein the clamping grove is defined on the supporting bracket;
wherein another end of the supporting leg is rotatably connected to the supporting bracket; the supporting leg is rotatable between a folding position, where the supporting leg is folded to the supporting bracket, and a walking position, where the supporting leg is substantially perpendicular to the supporting bracket and fastened to the supporting bracket by the fastening unit; when the supporting leg is rotated to the walking position, the tenon part is fastened to the clamping groove; the tenon part is a tenon pole slidably connected to the supporting leg, wherein the tenon pole is slidable between a clamping position, where the tenon pole is inserted into the clamping groove, and a releasing position, where the tenon pole is separated from the clamping groove; and
a warning sign mounted to an upper side of the supporting bracket; the warning sign is covered by reflecting materials.

12. The warning device of claim 11, wherein when the supporting leg is rotated to the folding position, the supporting leg is substantially parallel to the supporting bracket and abuts the supporting bracket.

13. The warning device of claim 11, wherein the warning device comprises three walking units, one of the three walking units is connected to a central portion of a front side of the supporting bracket; another two walking units are respectively connected to two ends of a rear side of the supporting bracket.

14. The warning device of claim 11, wherein the warning device comprises four walking units, two of the four walking units are respectively connected to two ends of a front side of the supporting bracket; another two walking units are respectively connected to two ends of a rear side of the supporting bracket.

15-19. (canceled)

20. The warning device of claim 11, wherein the tenon pole includes a handle.
